(19) United States
(12) Patent Application Publication
(10) Pub. No.: US 2002/0100181 A1
(43) Pub. Date: Aug. 1, 2002

(54) Siding spacer with level

(76) Inventor: Bryan Chris Evans, Webster, TX (US)

Correspondence Address: Valerie Friedrich, 1350 NASA Road One, Ste. 200, Houston, TX, 77058, US

(21) Appl. No.: 09/772,235

(22) Filed: Jan. 29, 2001

(51) Int. Cl. G01D 21/00

(52) U.S. Cl. 33/647

(57) ABSTRACT

A tool for installation of horizontal siding strips having a flat front face and a rear face with a top and bottom portion, and having the top portion sloping rearwardly. The farther has a rearwardly projecting lip located at the bottom portion of the rear face and an upwardly projecting lip extending along the front face. A method for installing horizontal siding strips using the tool.

### FIELD OF THE INVENTION

This invention relates to a tool used to install siding materials used on the exterior, of commercial and residential buildings. The present invention further relates to a method of installing siding using the tool.

### BACKGROUND OF THE INVENTION

Horizontal siding materials are generally manufactured and sold in long strips, ranging from between four and twelve inches in height and between eight and eighteen feet in length. Siding thicknesses may vary slightly and are usually from about five-sixteenths inch to one inch in thickness. Such siding material is usually installed by placing a length of siding along the lowest point of the wall to be covered. An additional siding strip is then installed above or partially overlapping the top edge of the first siding strip. Additional strips are sequentially added, each one installed above or partially overlapping the previous strip. When installing such siding, care must be taken to equally space the entire length of each strip with respect to the previous siding strip and to level the entire length of each strip. Such spacing and leveling are extremely important, as failure to do so will result in a surface with slanted siding giving an unsightly appearance. The larger the surface to be covered, the more critical exact spacing and leveling become to the final appearance and the more expensive any problems become to correct.

Because of the length and the materials of construction of siding strips, each strip tends to be rather heavy, each strip weighing between about one and forty pounds. Consequently, installation of siding can be difficult, particularly when attempting to maintain exact spacing and leveling. One technique for maintaining spacing and leveling employs standard levels and tape measures. Such method, however, is unsatisfactory, as a certain amount of uncertainty is inherent in reading such measuring devices. Such uncertainties are additive and can result in quite substantially uneven spacing and leveling over a large area. To overcome this problem, a number of devices have been manufactured to assist in installing siding. Such devices are disclosed in U.S. Pat. Nos. 5,291,719; 4,836,517; and 4,862,669. Each of these devices, however, are quite complicated to use, requiring at least two hands to operate leaving no hand free to manipulate the siding strip.

Other devices intended to permit a single person to install siding have been disclosed. For example, in U.S. Pat. No. 4,937,950 a device which holds one end of a siding strip in place while the installer nails the other end of the siding strip is disclosed. Like the other prior art devices discussed above, the '950 device is a multiple component device requiring both hands to fix in place and to attach a strip of siding within the device. Consequently, the '950 device cannot be used with a single hand and does not provide a quick method for spacing and leveling siding strips.

### SUMMARY OF THE INVENTION

The tool of the present invention provides an easy and exactly reproducible manner for spacing and leveling sequential strips of siding. The tool of the present invention is easy to use as it requires only one hand to operate while the installers other hand may be used to nail or otherwise fasten the siding strip to the wall. Furthermore, the tool of the present invention requires almost no dexterity for use leaving the installers more dexterous hand for fastening the siding strip. The method of the present invention which utilizes the tool of the present invention permits rapid, efficient and exact installation of siding strips.

### BRIEF DESCRIPTION OF THE DRAWINGS

FIG. 1 is a planar view of the side of the tool of the present invention.

FIG. 2 is a planar view of the front face of the tool of the present invention.

FIG. 3 is a planar view of the side of the tool of the present invention in place during installation of a second piece of siding over a first piece of siding with both siding pieces shown in dashed lines.

### DETAILED DESCRIPTION OF THE INVENTION

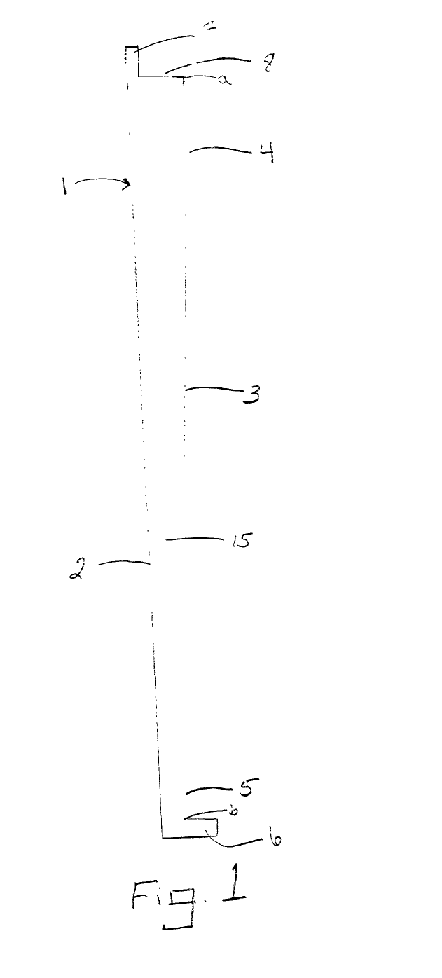

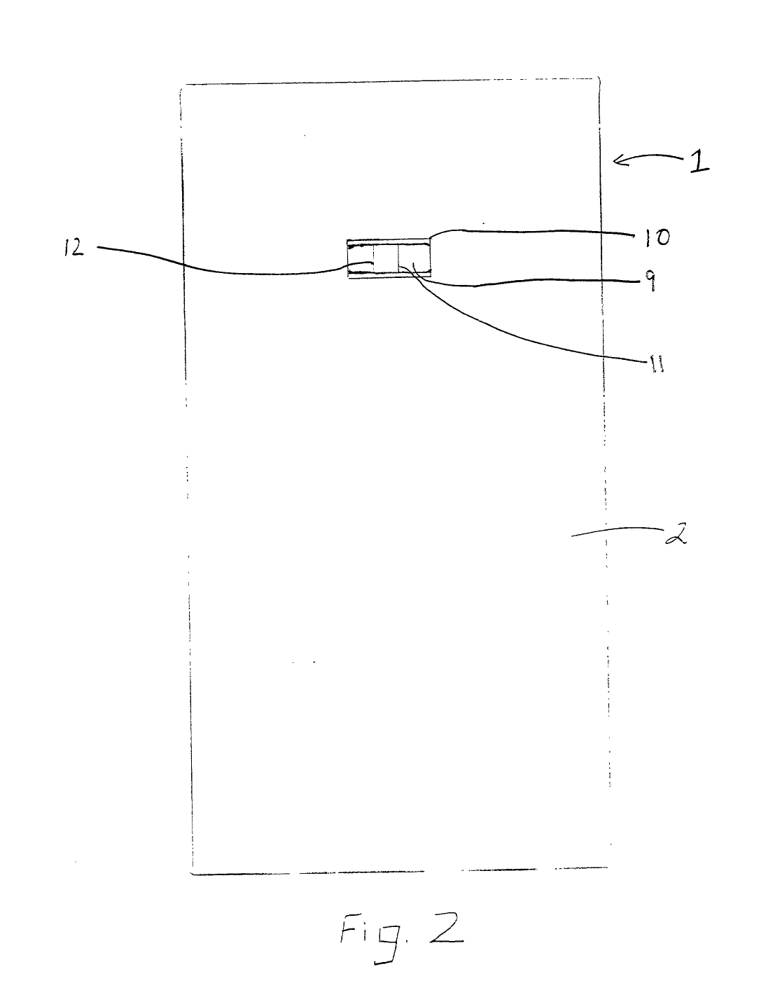

Referring first to FIG. 1, the tool 1 is a metal plate having two identical side edges 15 and 16 (not shown), a flat front face 2, a rear face 3 having a top 4 and bottom 5 portion, the top portion sloping away from the flat front face 1. The tool further has a horizontal lip 6 projecting rearwardly at the bottom portion 5 of rear face 3. Flat front face 2 further has a vertical lip 7 projecting upward from a top surface 8. The distance between points a and b on rear face 3 will be slightly less than or about the height of the siding strip to be installed and will vary from about four inches to twelve inches. Referring now to FIG. 2, the flat front face 2 of tool 1 is shown. A level 9 is held within a recess 10 formed in front face 2. As illustrated in FIG. 2, the level is a type commonly referred to as a bubble level having a pair of score marks 11 and 12. It will be understood that a level may be held within a recess 10 (as shown) or a through-face opening in flat front face 2. Alternatively, a level may be attached to the surface of flat front face 2. In the preferred embodiment, the level is recessed sufficiently deeply within the tool 1 so that a hand may be placed flatly against flat front face 2 during use.

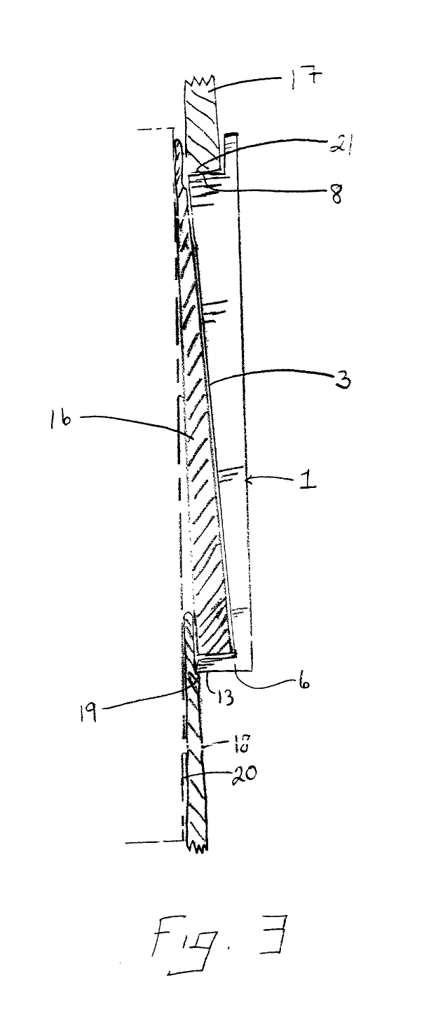

Horizontal siding strips are installed using tool 1 according to the method of the present invention. Referring now to FIG. 3, tool 1 is shown in place during use. FIG. 3 depicts a first siding strip 16, and a partial second siding strip 17, and a partial third siding strip 18, of horizontal siding, shown with diagonal hatching. Siding strips 16, 17 and 18 are installed on a support wall 20, indicated by dashed lines. An installer rests a lower edge 13 of horizontal lip 6 of tool 1 on a ridge 19 in siding strip 18. As shown in FIG. 3, the slope of rear face 3 is such as to accommodate the sloping face of siding strip 16. Once in place, the installer rests a bottom edge 21 of siding strip 17 onto top surface 8. Level 9 is referred to in order to assure that siding strip 17 is installed levelly. The a--b distance of tool 1 assures that siding strip 17 is spaced properly. While holding tool 1 in place with siding strip 17 resting on top surface 8, siding strip 17 is nailed into supporting wall 20.

I claim:

1. A siding spacer comprising:
a substantially flat front face,
a rear face having top and bottom portions and a top surface, said top portion sloping rearwardly away from said front face;
a horizontal lip extending rearwardly at said bottom portion of said rear face;
a vertical lip extending upward from said top surface along said front face; and
a level disposed within said front face.

2. A method of installing horizontal siding strips, said siding strips having top and bottom portions and front and rear faces and horizontal ridges located in said top portion, comprising the steps of:
installing a first siding strip at the lowermost portion of a support wall, such that said rear face is adjacent to said support wall,
placing said horizontal lip of said siding spacer of claim 1 on said horizontal ridge so that said rear face of said siding spacer rests against said front face of said first siding strip,
placing the bottom portion of a second siding strip on said top surface of said siding spacer,
tilting said siding spacer until said level of said siding spacer indicates levelness,
nailing said second siding strip to said support wall.
